(19) United States
(12) Patent Application Publication
(10) Pub. No.: US 2025/0042618 A1
(43) Pub. Date: Feb. 6, 2025

(54) A RECLOSABLE FLEXIBLE POUCH AND METHOD AND APPARATUS FOR MANUFACTURING RECLOSABLE FLEXIBLE POUCHES

(71) Applicant: Fameccanica.Data S.p.A., San Giovanni Teatino Chieti (IT)

(72) Inventor: Diego GUALTIERI, San Giovanni Teatino Chieti (IT)

(21) Appl. No.: 18/717,695

(22) PCT Filed: Nov. 14, 2022
(86) PCT No.: PCT/IB2022/060922

§ 371 Date: Jun. 7, 2024

(30) Foreign Application Priority Data
Dec. 10, 2021 (EP) 21213592.5

(51) Int. Cl. B65D 33/25; B31B 70/81; B31B 155/00; B31B 160/10

(52) U.S. Cl. CPC B65D 33/25; B31B 70/8132; B31B 2155/0014; B31B 2160/10

(57) ABSTRACT

A reclosable flexible pouch having first and second interlockable closure formations integrally formed in two longitudinal side portions of a continuous flexible sheet.

### FIELD OF THE INVENTION

The present invention relates to reclosable flexible pouches, also known as stand-up pouches or Doypacks (a trademark associated with the pouches).

The present invention also relates to a method and to an apparatus for manufacturing reclosable flexible pouches.

### PRIOR ART

A stand-up pouch or Doypack is a type of flexible packaging which is able to stand erect on its bottom for display, storage, and use. It is a type of plastic bag commonly used for food products. The bottom part of a stand-up pouch is gusseted to provide support for display or use. The most common pouch has bottom gussets to form a “W” which opens to form a flat bottom.

The flexible pouches are usually constructed of multi-layer materials: various plastic films, paper, barrier layers, etc. Pouches are often printed with graphics or sometimes have attached labels. The materials must have specialized heat-seal properties to allow conversion into pouches.

The packaging machinery involved typically forms the pouches from pre-printed roll stock. The preformed pouches are shipped to a packager where they are filled, and the top is sealed.

Inclusion of reclosable zip strips in Doypack pouches is common. Typically, the pouch has two opposite flexible sheets having at their top portions internal interlockable plastic strips which are reclosable to keep the pouch airtight after its opening.

Zip strips feature flanged interlockable profiles that create a reliable seal when pressed together. Some types of zip strip employ a slider to open and close the pouch.

The zip component of the packaging is supplied on a continuous roll and is inserted between the upper and lower webs of the packaging film. The zip may be bonded to the packaging film by a heat activated adhesive that is pre-applied to the backing of the zip.

Zip strips are often formed by extrusion, which involves the following problems:
low process speeds,
extremely high temperatures and pressures,
need for cooling processes using water,
impossibility to make intermittent shapes in the direction of advancement of the raw material.

### OBJECT AND SUMMARY OF THE INVENTION

The object of the present invention is to provide a reclosable flexible pouch which overcomes the problems of the prior art, and which simplifies and reduces the costs involved in forming the interlockable zip strips.

According to the invention, this object is achieved by a reclosable flexible pouch having the features of claim 1.

According to another aspect, the present invention relates to provide a method and apparatus for manufacturing reclosable flexible pouches having the features of claims 8 and 13.

The claims form an integral part of the technical disclosure provided here in relation to the invention.

### BRIEF DESCRIPTION OF THE DRAWINGS

The present invention will now be described with reference to the attached drawings, provided purely by way of non-limiting example, wherein:

FIG. 1 is a schematic side view of an apparatus for producing reclosable pouches according to the present invention,

FIGS. 2-6 are schematic plan views showing different steps of a method for manufacturing reclosable pouches according to the present invention,

FIG. 7 is a schematic perspective view of the unit indicated by the arrow VII in FIG. 1,

FIG. 8 is a schematic enlarged detail of the closure formations indicated by the arrow VIII in FIG. 4,

FIG. 9 is a schematic view showing the closure formations of FIG. 8 in the interlocked position,

FIGS. 10-12 are schematic enlarged views showing possible shapes different of mutually interlockable projections and recesses of the closure formations, and

FIG. 13 is a perspective view of a reclosable pouch according to the present invention.

It should be appreciated that the attached drawings are schematic and not to scale with respect to real products. Various figures may not be represented in the same scale. Also, in various figures some elements may not be shown to better show other elements.

### DETAILED DESCRIPTION

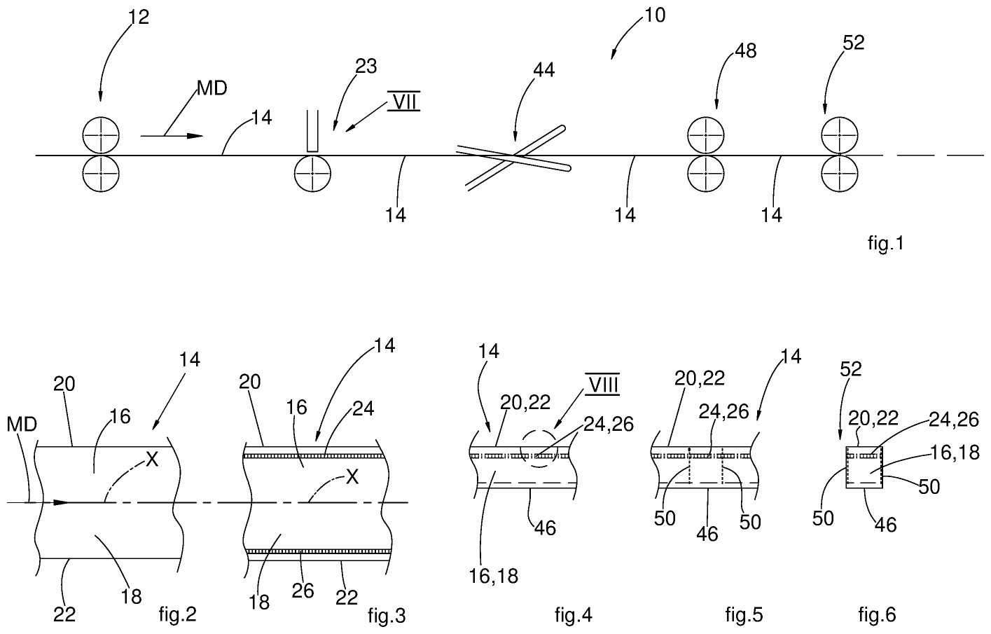

With reference to FIG. 1 numeral reference 10 indicates an apparatus for producing reclosable flexible pouches.

With reference to FIGS. 1 and 2, the apparatus 10 comprises a feeding device 12 configured for feeding in a machine direction MD a continuous flexible sheet 14 having a longitudinal axis X extending along the machine direction MD.

The continuous flexible sheet 14 may be unwound from a reel and may be printed with graphics. The continuous flexible sheet 14 is made of a material having heat-seal properties. The continuous flexible sheet 14 may have a multilayer structure comprising various plastic films, paper, air barrier layers, etc, as is common in packaging materials used for packaging food products. The continuous flexible sheet 14 may have at least one outer layer of thermoformable material.

The continuous flexible sheet 14 may be made of a biodegradable and/or compostable material. The biodegradability of materials is defined according to the standard EN13432. In a possible embodiment the continuous flexible sheet 14 may be made of biodegradable and compostable bioplastic materials such as MATER-BI© or SPLASTICA.

In a possible embodiment the continuous flexible sheet 14 may be made of a material recyclable with paper. The characteristics of the materials that can be recycled with paper may be defined by the standard Aticelca© 501/2017. The wording and icon “RECYCLABLE WITH PAPER—Aticelca 501” on packages inform consumers about the recyclability with paper. The Aticelca® 501/2017 standard defines a test for recyclability of products (e.g. packaging material, printed material, articles for domestic use, etc.) made of more than 50% by weight of cellulosic materials.

With reference to FIG. 2, the continuous flexible sheet 14 has two longitudinal side portions 16, 18 opposite to each other with respect to the longitudinal axis X and two opposite longitudinal side edges 20, 22 parallel to the longitudinal axis X.

With reference to FIGS. 1, 3 and 7, the apparatus 10 comprises a forming unit 23 configured for integrally forming in the two longitudinal side portions 16, 18 of the continuous flexible sheet 14 first and second interlockable closure formations 24, 26 extending longitudinally adjacent to respective longitudinal side edges 20, 22.

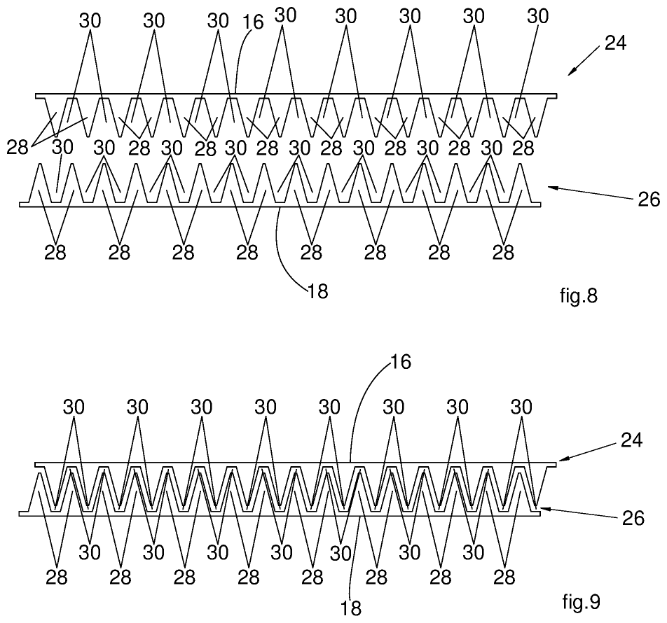

With reference to FIGS. 8 and 9, each of the first and second interlockable closure formations 24, 26 has a succession of projections 28 and recesses 30 which are integrally formed on the surface of the two longitudinal side portions 16, 18 of the continuous flexible sheet 14 as the continuous flexible sheet 14 moves through the forming unit 23.

As shown in FIG. 9, the projections 28 of the first closure formation 24 are configured for interlocking with the recesses 30 of the second closure formation 26 and the projections 28 of the second closure formation 26 are configured for interlocking with the recesses 30 of the first closure formation 24.

In the configuration of FIG. 3 in which the continuous flexible sheet 14 is flat at the exit of the forming unit 23 the projections 30 of each of the first and second closure formations 24, 26 are transversally aligned to corresponding recesses 30 of the other closure formation 24, 26 and the recesses 30 of each of the first and second closure formations 24, 26 are transversally aligned to corresponding projections 28 of the other closure formation 24, 26.

The first and second interlockable closure formations 24, 26 may be equal to each other and offset with respect to each other in the longitudinal direction X.

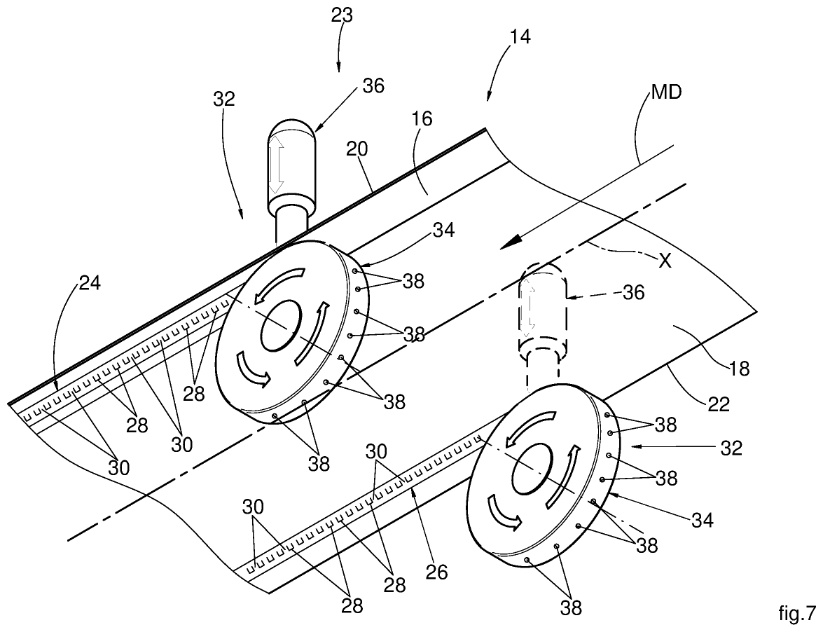

With reference to FIG. 7, the forming unit 23 may comprise two ultrasonic forming devices 32, each including an anvil 34 and a respective ultrasonic horn 36. The anvil 34 may be formed by a wheel rotating about an axis transverse to the machine direction MD. The ultrasonic horn 36 may include a vibrating rod cooperating with the outer surface of the anvil 34. In a possible embodiment, the ultrasonic horn may be formed by a vibrating roller rotating about an axis transverse to the machine direction MD.

The first and second interlockable closure formations 24, 26 may be formed by a method similar to that disclosed in WO2010/085492. This document discloses an apparatus and process for forming micro-hooks on a substrate for use as hook-type fasteners in touch fastening systems, wherein vibration energy is used to soften a substrate which is positioned between a mould and a source of vibration. The mould includes a plurality of cavities into which the softened substrate is forced to form the projections. The substrate may comprise a film, sheet, web, composite, laminate, etc. The source of vibration may be an ultrasonic horn. The process to form such micro-hooks may be operated in a continuous, semi-continuous or intermittent manner.

With reference to FIG. 7, each anvil 34 has a plurality of cavities 38 open on its outer cylindrical surface. The ultrasonic horns 36 compress the respective longitudinal side portions 16, 18 of the continuous flexible sheet 14 against the outer cylindrical surfaces of the respective anvils 34 as the continuous flexible sheet 14 moves in the machine direction MD.

The vibrating energy produced by the ultrasonic horns 36 liquefies or fluidifies locally the thermoformable material of the outer layer of the continuous flexible sheet 14, which penetrates in a fluid or liquid state in the cavities 38 of the anvils 34. The material of the continuous flexible sheet 14 which penetrates in the cavities of the anvils 34 cools in contact with the walls of the cavities 38 and forms projections 28 alternated to recesses 30 integral with the continuous flexible sheet 14.

As schematically shown in FIG. 7, at the exit of the forming unit 23 the continuous flexible sheet 14 has integrally formed first and second closure formations 24, 26. The two anvils 34 of the two ultrasonic forming devices 32 are operated with a precise angular offset, such that the projections 30 of the first closure formation 24 are transversally aligned to corresponding recesses 30 of the second closure formation 26 and the recesses 30 of the first closure formation 24, are transversally aligned to corresponding projections 28 of the second closure formation 26, and vice versa.

The first and second closure formations 24, 26 may be formed intermittently in the machine direction MD. The intermittent arrangement of the closure formations 24, 26 may be obtained by providing on the outer surface of each anvil 34 an intermittent pattern of cavities 38. Alternatively, each anvil 34 may have a continuous pattern of cavities 38 and the intermittent closure formations 24, 26 may be formed by intermittently turning off the ultrasonic horns 36. As a further alternative, each anvil 34 may have a continuous pattern of cavities 38 and the intermittent first and second closure formations 24, 26 may be formed by intermittently detaching the ultrasonic horns 36 from the outer cylindrical surfaces of the respective anvils 34.

In a possible embodiment, the forming unit 23 may be a thermomechanical forming unit, in which the material of the longitudinal side portions 16, 18 of the continuous flexible sheet 14 is locally liquified or fluidified by heating and compression.

In order to form projections and cavities with dimensions sufficient for an effective interlocking, the continuous flexible sheet 14 may be a monolayer sheet of thermoformable material or a multilayer sheet having an outer layer of thermoformable material, having a weight comprised between 10-300 g/m².

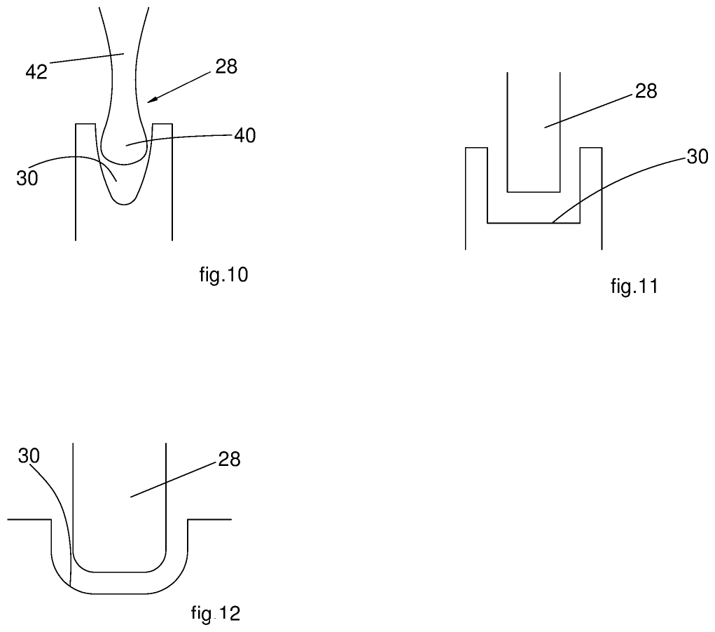

The cavities 38 of the anvil 34 may be shaped to form projections 28 and recesses 30 with different shapes and dimensions. FIGS. 10-12 schematically show different possible shapes of the projections 28 and recesses 30 of the closure formations 24, 26.

In the embodiment of FIG. 10 each of the projections 28 has a rounded head portion 40 connected to a narrower shank portion 42, and each of the recesses 30 has a V-shape with curved sides.

In the embodiment of FIG. 11 each of the projections 28 has a rectangular shape and each of the recesses 30 has a U-shape.

In the embodiment of FIG. 12 the rectangular projections 28 and the U-shaped recesses 30 have respective rounded corners.

With reference to FIGS. 1 and 4, the apparatus 10 comprises a folding unit 44 configured for folding the continuous flexible sheet 14 about at least one folding line 46 parallel to the longitudinal axis X.

In a possible embodiment, the folding unit 44 may be configured for folding the continuous flexible sheet 14 about three folding lines 46 parallel to the longitudinal axis X in a W-shaped configuration which opens to form a flat bottom.

After the longitudinal folding, the two longitudinal side portions 16, 18 of the continuous flexible sheet 14 are overlapped to each other so that the first and second closure formations 24, 26 face each other.

The folded continuous flexible sheet 14 has a closed edge at the folding line(s) 46 and an open edge at the mutually facing side edges 20, 22.

With reference to FIGS. 1 and 5, the apparatus 10 comprises a sealing unit 48 configured for joining to each other the two longitudinal side portions 16, 18 of the continuous folded flexible sheet 14 along sealing lines 50 extending between the closed edge 46 and the open edges 20, 22 of the continuous folded flexible sheet 14. The sealing unit 48 may be a welding unit, for example an ultrasonic or thermocompression welding unit.

With reference to FIGS. 1 and 5, the apparatus 10 comprises a cutting unit 52 configured for cutting the continuous folded flexible sheet 14 along cutting lines extending over the welding lines 50, such that each cutting line is preceded and followed by a portion of a respective welding line 50. The cutting lines extend along the whole width of the said continuous folded flexible sheet 14 so that downstream of the cutting unit 52 a continuous array of individual reclosable pouches 52 is formed.

The individual reclosable pouches 52 are then filled. After filling, the mutually facing first and second closure formations 24, 26 are interlocked with each other and the reclosable pouches 52 are sealed between the edges 20, 22 and the mutually interlocked closure formations 24, 26, e.g. by welding.

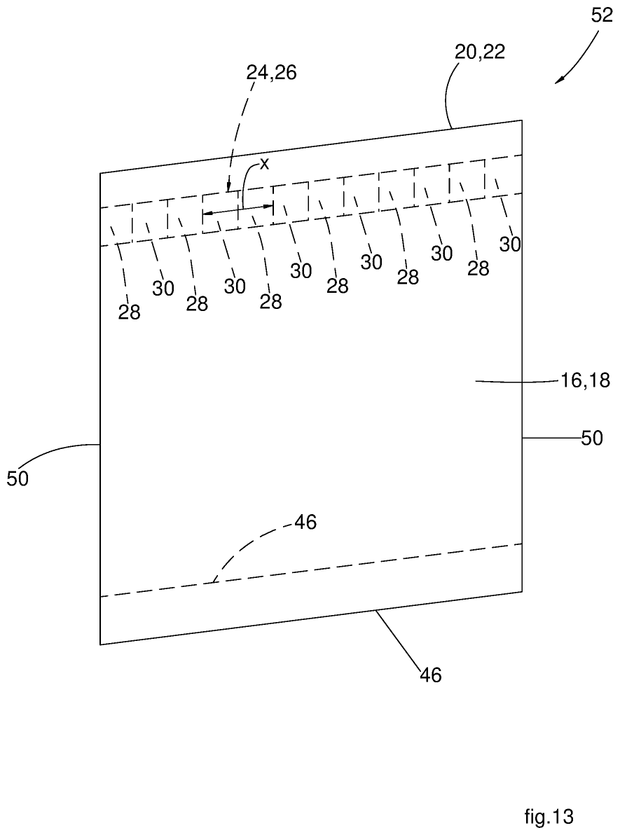

FIG. 13 schematically shows a reclosable pouch 52 according to the present invention.

The reclosable flexible pouch 52 comprises a flexible sheet 14 folded about at least one folding line 46 (preferably about three parallel folding lines 46).

The flexible sheet 14 has first and second mutually facing front portions 16, 18 having respective side edges joined to each other along two sealing lines 50. The first and second mutually facing front portions 16, 18 have respective top edges 20, 22 and first and second interlockable closure formations 24, 26 adjacent to respective top edges 20, 22.

The first and second interlockable closure formations 24, 26 are integrally formed with the respective mutually facing front portions 16, 18.

Each of the first and second interlockable closure formations 24, 26 has a succession of projections 28 and recesses 30 extending along a longitudinal direction X and configured for interlocking with the recesses 30 and projections 28 of the other closure formation 24, 26.

The projections 28 of each of the first and second interlockable closure formations 24, 26 are transversely aligned to corresponding 30 of the other closure formation 24, 26 and the recesses 30 of each of the first and second interlockable closure formations 24, 26 transversely aligned to are corresponding projections 28 of the other closure formation 24, 26.

In a possible embodiment, the first and second interlockable closure formations 24, 26 are equal to each other and offset with respect to each other along the longitudinal direction X.

The main advantages of the method according to the present invention are the following:
low process temperatures,
low power and energy required,
high dimensional stability and precision of the reclosable closure formations,
high manufacturing speeds,
possibility of forming the closure formations in line with the formation of the pouches,
possibility of customizing the shapes of the closure formations by appropriately forming the anvils 34.

Of course, without prejudice to the principle of the invention, the details of construction and the embodiments can be varied, even significantly, with respect to those illustrated here without departing from the scope of the invention as defined by the following claims.

1. A reclosable flexible pouch, comprising:
a flexible sheet folded about at least one folding line and having first and second mutually facing front portions having respective side edges joined to each other along two sealing lines, the first and second mutually facing front portions having respective top edges and first and second interlockable closure formations adjacent to the respective top edges,
wherein said first and second interlockable closure formations are integrally formed with the respective first and second mutually facing front portions, and
wherein each of said first and second interlockable closure formations has a succession of projections and recesses extending along a longitudinal direction such that the projections and recesses of one of the first and second interlockable closure formations are configured for interlocking with the recesses and projections of the other of the first and second interlockable closure formations.

2. The reclosable flexible pouch of claim 1, wherein the projections of one of said first and second interlockable closure formations are transversely aligned to corresponding recesses of the other of said first and second interlockable closure formations and the recesses of one of said first and second interlockable closure formations are transversely aligned to corresponding projections of the other of said first and second interlockable closure formations.

3. The reclosable flexible pouch of claim 1, wherein said first and second interlockable closure formations are equal to each other and offset with respect to each other along said longitudinal direction.

4. The reclosable flexible pouch of claim 1, wherein said flexible sheet is made of a biodegradable and/or compostable material according to the standard EN13432.

5. The reclosable flexible pouch of claim 1, wherein said flexible sheet is recyclable with paper according to the standard Aticelca© 501/2017.

6. The reclosable flexible pouch of claim 1, wherein said flexible sheet is a monolayer sheet of thermoformable material or a multilayer sheet comprising at least one outer layer of thermoformable material.

7. The reclosable flexible pouch of claim 6, wherein said flexible sheet has a weight comprised between 10-300 g/m².

8. A method for manufacturing reclosable flexible pouches, comprising:
feeding in a machine direction a continuous flexible sheet having a longitudinal axis extending along said machine direction, two longitudinal side portions opposite to each other with respect to the longitudinal axis and two opposite longitudinal side edges,
integrally forming in said two longitudinal side portions first and second interlockable closure formations extending longitudinally adjacent to respective longitudinal side edges, wherein each of said first and second interlockable closure formations has a succession of projections and recesses such that the projections and recesses of one of the first and second interlockable closure formations are configured for interlocking with the recesses and projections of the other of the first and second interlockable closure formations,
folding said continuous flexible sheet about at least one folding line parallel to said longitudinal axis, and overlapping to each other said two longitudinal side portions to form a continuous folded flexible sheet having a closed edge and an open edge,
joining to each other the two overlapped longitudinal side portions along sealing lines, and
cutting said continuous folded flexible sheet along cutting lines extending over said sealing lines such that each cutting line is preceded and followed by a portion of a respective sealing line,
wherein said first and second interlockable closure formations are formed by subjecting said continuous flexible sheet to ultrasonic compression or to thermomechanical compression.

9. The method of claim 8, wherein the projections of one of said first and second interlockable closure formations are transversely aligned to corresponding recesses of the other of said first and second interlockable closure formations and the recesses of one of said first and second interlockable closure formations are transversely aligned to corresponding projections of the other of said first and second interlockable closure formations.

10. The method of claim 8, wherein said first and second interlockable closure formations are formed by locally liquifying or fluidifying thermoformable material on the surface of said continuous flexible sheet and inserting the liquified or fluidified thermoformable material into cavities of an anvil.

11. The method of any of claim 8, wherein each of said first and second interlockable closure formations is formed intermittently in said machine direction.

12. An apparatus for manufacturing reclosable flexible pouches, comprising:
a feeding device configured for feeding in a machine direction a continuous flexible sheet having a longitudinal axis extending along said machine direction, two longitudinal side portions opposite to each other with respect to the longitudinal axis and two opposite longitudinal side edges,
a forming unit configured for integrally forming in said two longitudinal side portions first and second interlockable closure formations extending longitudinally adjacent to respective longitudinal side edges,
wherein the forming unit is configured for forming in each of said longitudinal side portions a succession of projections and recesses such that the projections and recesses of one of the first and second interlockable closure formations are configured for interlocking with the recesses and projections of the other of the first and second interlockable closure formations,
wherein the forming unit comprises first and second ultrasonic forming devices each including an anvil having an outer surface provided with cavities and an ultrasonic horn cooperating with the outer surfaces of the respective anvil,
a folding unit configured for folding said continuous flexible sheet about at least one folding line parallel to said longitudinal axis, and for overlapping to each other said two longitudinal side portions to form a continuous folded flexible sheet having a closed edge and an open edge,
a sealing unit configured for joining to each other the two overlapped longitudinal side portions along sealing lines, and
a cutting unit configured for cutting said continuous folded flexible sheet along cutting lines extending over said sealing lines such that each cutting line is preceded and followed by a portion of a respective sealing line.

13. The apparatus of claim 12, wherein the anvils of the two ultrasonic forming devices are operated with an angular offset, such that the projections of the first closure formation are transversally aligned to corresponding recesses of the second closure formation and the recesses of the first closure formation are transversally aligned to corresponding projections of the second closure formation, and vice versa.

14. A reclosable flexible pouch manufactured by a method according to claim 8.
